(19) United States
(12) Patent Application Publication
(10) Pub. No.: US 2026/0002786 A1
(43) Pub. Date: Jan. 1, 2026

(54) VEHICLE OPERATION

(71) Applicant: Ford Global Technologies, LLC, Dearborn, MI (US)

(72) Inventors: Constantin Giebel, Muelheim Ruhr/NRW (DE); Hessel C. van Dijk, Roesrath/NRW (DE); Armin Lepold, Leichlingen (DE); Jérémy Couval, Köln/NRW (DE); Mathias Sprenger, Lenggries/Bayern (DE)

(73) Assignee: Ford Global Technologies, LLC, Dearborn, MI (US)

(21) Appl. No.: 18/754,275

(22) Filed: Jun. 26, 2024

(51) Int. Cl. G01C 21/34; B60W 50/00; B60W 50/029; G01C 21/00

(52) U.S. Cl. CPC G01C 21/3461; B60W 50/0097; B60W 50/029; G01C 21/3815

(57) ABSTRACT

Based on inputting collected data of a host vehicle to a machine learning program, a predicted load on a wheel of the host vehicle and a predicted vertical displacement of the wheel are determined via output from the machine learning program. A road disturbance traversed by the host vehicle is identified based on at least one of the predicted load and the predicted vertical displacement. Map data is updated to include the road disturbance.

### BACKGROUND

A vehicle can be equipped with electronic and electro-mechanical components, e.g., computing devices, networks, sensors and controllers, etc. A vehicle computer can acquire data regarding the vehicle's environment and can operate the vehicle or at least some components thereof based on the data. Vehicle sensors can provide data concerning routes to be traveled and objects to be accounted for in the vehicle's environment. Operation of the vehicle can be performed according to acquiring data regarding objects in a vehicle's environment while the vehicle is being operated.

### BRIEF DESCRIPTION OF THE DRAWINGS

FIG. 1 is a block diagram illustrating an example vehicle control system.

FIGS. 2A-2B are diagrams illustrating a host vehicle operating on an exemplary road including an exemplary road disturbance.

FIG. 3 is a diagram illustrating a side view of the host vehicle in FIG. 2A.

FIG. 4 is an example neural network.

FIG. 5 is a block diagram illustrating an example simulation system to generate ground truth data for the neural network.

FIG. 6 an example flowchart of an example process for operating a vehicle.

### DETAILED DESCRIPTION

A vehicle can include sensors that collect data while the vehicle is operating. For example, the sensors can collect data regarding objects to be accounted for in the environment around the vehicle. Typically, the vehicle operates along a plurality of routes to collect the sensor data of the environment. Upon collecting the data of the environment, a computer in the vehicle can use the data to operate the vehicle within the environment while accounting for objects detected in the environment. However, the data of the environment may lack information regarding a road disturbance (i.e., a road surface deviation) in a road along which the vehicle is traveling because the computer may be unable (e.g., due to vehicle sensor configurations and/or vehicle packaging constraints) to determine or derive a load exerted on a vehicle wheel or a vertical displacement of the vehicle wheel caused by the vehicle traversing (i.e., traveling across) the road disturbance. As such, the computer may be unable to account for the road disturbance when operating the vehicle in the environment.

A system includes a computer including a processor and a memory, the memory storing instructions executable by the processor such that the processor is programmed to, based on inputting collected data of a host vehicle to a machine learning program, determine a predicted load on a wheel of the host vehicle and a predicted vertical displacement of the wheel via output from the machine learning program. The processor is further programmed to identify a road disturbance traversed by the host vehicle based on at least one of the predicted load and the predicted vertical displacement. The processor is further programmed to update map data to include the road disturbance.

The processor may be further programmed to determine a classification of a vehicle component based on at least one of the predicted load and the predicted vertical displacement. The classification may be one of healthy and unhealthy. The processor can be further programmed to output a message based on the vehicle component being unhealthy.

The processor may be further programmed to provide the updated map data to a remote computer, the computer being included in the host vehicle and the remote computer being a server.

The system may include the remote computer, including a second processor and a second memory storing instructions executable by the second processor such that the remote computer may be programmed to update a map based on aggregated data including updated map data from a plurality of vehicles. The second processor may be further programmed to provide the updated map to the computer and to a second computer.

The system may include the second computer, including a third processor and a third memory storing instructions executable by the third processor such that the second computer may be programmed to, upon detecting the road disturbance via the updated map, adjust a component parameter of a second vehicle based on the road disturbance. The third processor may be further programmed to operate the second vehicle based on the adjusted component parameter while traversing the road disturbance. The second computer may be included in the second vehicle.

The processor may be further programmed to, upon detecting, via a map, a second road disturbance, determine a planned path based on the second road disturbance. The second road disturbance may be identified based on at least one of a second predicted load on a target wheel of a second vehicle and a second predicted vertical displacement of the target wheel. Based on inputting collected data of the second vehicle to the machine learning program, the second predicted load and the second predicted vertical displacement may be determined via output from the machine learning.

The processor may be further programmed to, upon determining the planned path extends around the second road disturbance, operate the host vehicle along the planned path.

The processor may be further programmed to, upon determining the planned path traverses the second road disturbance, adjust a component parameter of the host vehicle based on the second road disturbance. The processor may be further programmed to operate the host vehicle based on the adjusted component parameter while traversing the second road disturbance.

A method includes, based on inputting collected data of a host vehicle to a machine learning program, determining a predicted load on a wheel of the host vehicle and a predicted vertical displacement of the wheel via output from the machine learning program. The method further includes identifying a road disturbance traversed by the host vehicle based on at least one of the predicted load and the predicted vertical displacement. The method further includes updating map data to include the road disturbance.

The method can further include providing, via a first computer, the updated map data to a remote computer. The first computer may be included in the host vehicle and the remote computer is a server.

The method can further include updating, via the remote computer, a map based on aggregated data including updated map data from a plurality of vehicles. The method can further include transmitting the updated map to the computer and to a second computer.

The method can further include, upon detecting the road disturbance via the updated map, adjusting, via the second computer, a component parameter of a second vehicle based on the road disturbance. The method can further include operating, via the second computer, the second vehicle based on the adjusted component parameter while traversing the road disturbance. The second computer may be included in the second vehicle.

The method can further include, upon detecting, via a map, a second road disturbance, determining a planned path based on the second road disturbance.

The method can further include, based on inputting collected data of the second vehicle to the machine learning program, determining a second predicted load on a target wheel of a second vehicle and a second predicted vertical displacement of the target wheel via output from the machine learning. The method can further include identifying the second road disturbance based on at least one of the second predicted load and the second predicted vertical displacement.

The method can further include, upon determining the planned path extends around the second road disturbance, operating the host vehicle along the planned path.

The method can further include, upon determining the planned path traverses the second road disturbance, adjusting a component parameter of the host vehicle based on the second road disturbance. The method can further include operating the host vehicle based on the adjusted component parameter while traversing the second road disturbance.

Further disclosed herein is a computing device programmed to execute any of the above method steps. Yet further disclosed herein is a computer program product, including a computer readable medium storing instructions executable by a computer processor, to execute an of the above method steps.

As disclosed herein, a computer can input collected data of a vehicle to a machine learning program trained to output a predicted load exerted on a vehicle wheel and a predicted vertical displacement of a vehicle wheel. Predicting the load and the vertical displacement allows the computer to update map the displacement data to include identified road disturbances, which allows the computer to account for the identified road disturbances when operating the vehicle.

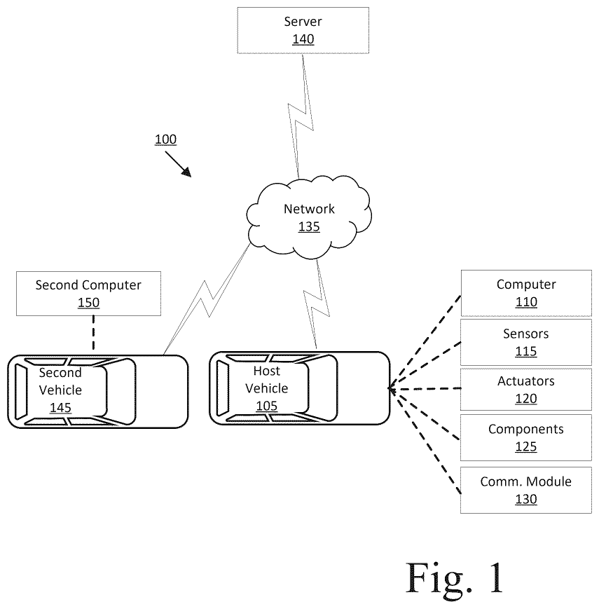

With reference to FIGS. 1-5, an example vehicle control system 100 includes a host vehicle 105. A vehicle computer 110 in the host vehicle 105 receives data from sensors 115. The vehicle computer 110 is programmed to, based on inputting collected data of the host vehicle 105 to a machine learning program, determine a predicted load L on a wheel 300 of the host vehicle 105 and a predicted vertical displacement V_{d} of the wheel 300 via output from the machine learning program. The vehicle computer 110 is further programmed to identify a road disturbance 215 traversed by the host vehicle 105 based on at least one of the predicted load L and the predicted vertical displacement V_{d}. The vehicle computer 110 is further programmed to update map data to include the road disturbance 215.

Turning now to FIG. 1, the host vehicle 105 includes the vehicle computer 110, sensors 115, actuators 120 to actuate various vehicle components 125, and a vehicle communications module 130. The communications module 130 allows the vehicle computer 110 to communicate with a remote server computer 140, and/or other vehicles (e.g., via a messaging or broadcast protocol such as Dedicated Short Range Communications (DSRC), cellular, and/or other protocol that can support vehicle-to-vehicle, vehicle-to infrastructure, vehicle-to-cloud communications, or the like, and/or via a packet network 135).

The vehicle computer 110 includes a processor and a memory such as are known. The memory includes one or more forms of computer-readable media, and stores instructions executable by the vehicle computer 110 for performing various operations, including as disclosed herein. The vehicle computer 110 can further include two or more computing devices operating in concert to carry out vehicle operations including as described herein. Further, the vehicle computer 110 can be a generic computer with a processor and memory as described above, and/or may include an electronic control unit (ECU) or electronic controller or the like for a specific function or set of functions, and/or may include a dedicated electronic circuit including an ASIC that is manufactured for a particular operation (e.g., an ASIC for processing sensor data and/or communicating the sensor data). In another example, the vehicle computer 110 may include an FPGA (Field-Programmable Gate Array) which is an integrated circuit manufactured to be configurable by a user. Typically, a hardware description language such as VHDL (Very High Speed Integrated Circuit Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming (e.g. stored in a memory electrically connected to the FPGA circuit). In some examples, a combination of processor(s), ASIC(s), and/or FPGA circuits may be included in the vehicle computer 110.

The vehicle computer 110 may include programming to operate one or more of vehicle propulsion, steering, transmission, climate control, interior and/or exterior lights, horn, doors, etc., as well as to determine whether and when the vehicle computer 110, as opposed to a human operator, is to control such operations.

The vehicle computer 110 may include or be communicatively coupled to (e.g., via a vehicle communications network such as a communications bus as described further below) more than one processor (e.g., included in electronic controller units (ECUs) or the like included in the host vehicle 105) for monitoring and/or controlling various vehicle components 125 (e.g., a transmission controller, a steering controller, etc.). The vehicle computer 110 is generally arranged for communications on a vehicle communication network that can include a bus in the host vehicle 105 such as a controller area network (CAN) or the like, and/or other wired and/or wireless mechanisms.

Via the host vehicle 105 network, the vehicle computer 110 may transmit messages to various devices in the host vehicle 105 and/or receive messages (e.g., CAN messages) from the various devices (e.g., sensors 115, an actuator 120, ECUs, etc.). Alternatively, or additionally, in cases where the vehicle computer 110 actually comprises a plurality of devices, the vehicle communication network may be used for communications between devices represented as the vehicle computer 110 in this disclosure. Further, as mentioned below, various controllers and/or sensors 115 may provide data to the vehicle computer 110 via the vehicle communication network.

Vehicle 105 sensors 115 may include a variety of devices such as are known to provide data to the vehicle computer 110. For example, the sensors 115 may include Light Detection And Ranging (LIDAR) sensor(s) 115, etc., disposed on a top of the host vehicle 105, behind a vehicle front windshield, around the host vehicle 105, etc., that provide relative locations, sizes, and shapes of objects surrounding the host vehicle 105. As another example, one or more radar sensors 115 fixed to vehicle 105 bumpers may provide data to provide locations of the objects, second vehicles, etc., relative to the location of the host vehicle 105. The sensors 115 may further alternatively or additionally, for example, include camera sensor(s) 115 (e.g. front view, side view, etc.) providing images from an area surrounding the host vehicle 105. In the context of this disclosure, an object is a physical (i.e., material) item that has mass and that can be represented by physical phenomena (e.g., light or other electromagnetic waves, or sound, etc.) detectable by sensors 115. Thus, the host vehicle 105, as well as other items including as discussed below, fall within the definition of “object” herein.

The vehicle computer 110 is programmed to receive data from one or more sensors 115 substantially continuously, periodically, and/or when instructed by a remote server computer 140, etc. The data may, for example, include a location of the host vehicle 105. Location data specifies a point or points on a ground surface and may be in a known form (e.g., geo-coordinates such as latitude and longitude coordinates obtained via a navigation system, as is known, that uses the Global Positioning System (GPS)). Additionally, or alternatively, the data can include a location of an object (e.g., a vehicle, a sign, a tree, etc.) relative to the host vehicle 105. As one example, the data may be image data of the environment around the host vehicle 105. In such an example, the image data may include one or more objects and/or markings (e.g., lane markings) on or along a road. Image data herein means digital image data (e.g., comprising pixels with intensity and color values) that can be acquired by camera sensors 115. The sensors 115 can be mounted to any suitable location in or on the host vehicle 105 (e.g., on a vehicle bumper, on a top of a vehicle, etc.) to collect images of the environment around the host vehicle 105.

The host vehicle 105 actuators 120 are implemented via circuits, chips, or other electronic and or mechanical components that can actuate various vehicle subsystems in accordance with appropriate control signals as is known. The actuators 120 may be used to control components 125, including propulsion and steering of a vehicle.

In the context of the present disclosure, a vehicle component 125 is one or more hardware components adapted to perform a mechanical or electro-mechanical function or operation-such as moving the host vehicle 105, slowing or stopping the host vehicle 105, steering the host vehicle 105, etc. Non-limiting examples of components 125 include a propulsion component (that includes, e.g., an internal combustion engine and/or an electric motor, etc.), a transmission component, a steering component (e.g., that may include one or more of a steering wheel, a steering rack, etc.), a suspension component (e.g., that may include one or more of a damper, e.g., a shock or a strut, a bushing, a spring, a control arm, a ball joint, a linkage, etc.), a park assist component, an adaptive cruise control component, an adaptive steering component, etc.

In addition, the vehicle computer 110 may be configured for communicating via a vehicle-to-vehicle communication module 130 or interface with devices outside of the host vehicle 105 (e.g., through a vehicle-to-vehicle (V2V) or vehicle-to-infrastructure (V2X) wireless communications (cellular and/or short-range radio communications, etc.) to another vehicle, and/or to a remote server computer 140 (typically via direct radio frequency communications)). The communications module 130 could include one or more mechanisms, such as a transceiver, by which the computers of vehicles may communicate, including any desired combination of wireless (e.g., cellular, wireless, satellite, microwave and radio frequency) communication mechanisms and any desired network topology (or topologies when a plurality of communication mechanisms are utilized). Exemplary communications provided via the communications module 130 include cellular, Bluetooth, IEEE 802.11, dedicated short range communications (DSRC), cellular V2X (CV2X), and/or wide area networks (WAN), including the Internet, providing data communication services. The label “V2X” is used herein for communications that may be vehicle-to-vehicle (V2V) and/or vehicle-to-infrastructure (V2I), and that may be provided by communication module 130 according to any suitable short-range communications mechanism (e.g., DSRC, cellular, or the like).

The network 135 represents one or more mechanisms by which a vehicle computer 110 may communicate with remote computing devices (e.g., the remote server computer 140, another vehicle computer, etc.). Accordingly, the network 135 can be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth®, Bluetooth® Low Energy (BLE), IEEE 802.11, vehicle-to-vehicle (V2V) such as Dedicated Short Range Communications (DSRC), etc.), local area networks (LAN) and/or wide area networks (WAN), including the Internet, providing data communication services.

The remote server computer 140 can be a conventional computing device (i.e., including one or more processors and one or more memories) programmed to provide operations such as disclosed herein. Further, the remote server computer 140 can be accessed via the network 135 (e.g., the Internet, a cellular network, and/or or some other wide area network).

A second vehicle 145 may include a second computer 150. The second computer 150 includes a second processor and a second memory such as are known. The second memory includes one or more forms of computer-readable media, and stores instructions executable by the second computer 150 for performing various operations, including as disclosed herein.

Additionally, the second vehicle 145 may include sensors, actuators to actuate various vehicle components, and a vehicle communications module. The sensors, actuators to actuate various vehicle components, and the vehicle communications module typically have features in common with the sensors 115, actuators 120 to actuate various host vehicle components 125, and the vehicle communications module 130, and therefore will not be described further to prevent redundancy.

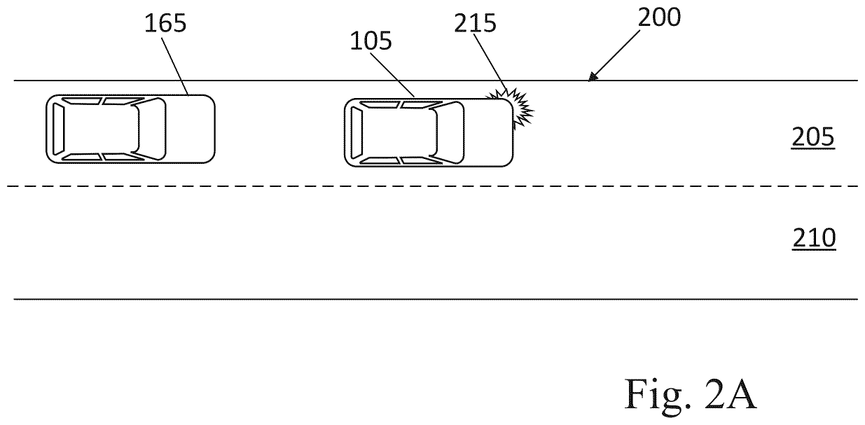

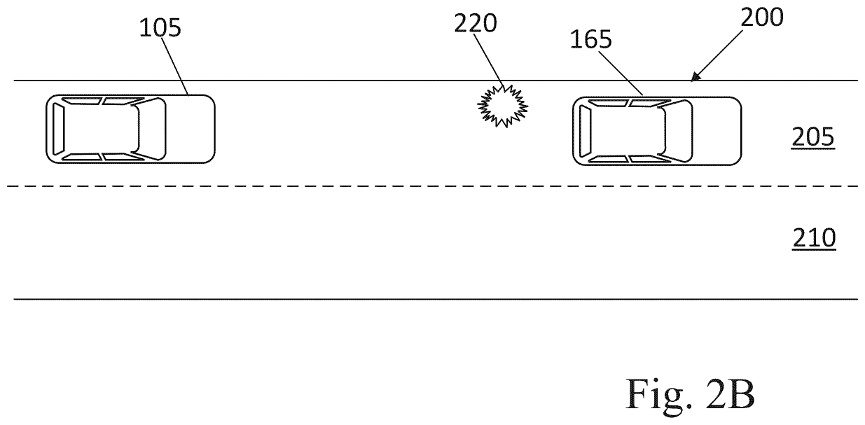

FIGS. 2A-2B are diagrams illustrating the host vehicle 105 operating in a host lane 205 of an example road 200. A lane is a specified area of the road for vehicle travel. A road in the present context is an area of a ground surface that includes any surface provided for land vehicle travel. A lane of a road is an area defined along a length of a road, typically having a width to accommodate only one vehicle, i.e., such that multiple vehicles can travel in a lane one in front of the other, but not abreast of, i.e., laterally adjacent, one another. A host lane 205 is a lane in which the host vehicle 105 is operating. The road 200 may include one or more target lanes 210. A target lane 210 is a lane in which the host vehicle 105 is not operating and that permits vehicle travel in a same direction as the host lane 205. A road disturbance 215 may be present on a ground surface of the road 200. A road disturbance 215 is a deviation relative to the ground surface of the road 200, i.e., an irregular vertical change of the road surface. The road disturbance 215 can be any type of protrusion on or depression in the ground surface (e.g., a speed bump, a pothole, rumble strips, etc.).

The road disturbance 215 may exist, at least partially, in the lane 205. For example, the road disturbance 215 may exist entirely within the lane 205, as shown in FIGS. 2A-2B. As another example, the road disturbance 215 may exist at least partially within two lanes that is, extending across a lane marker (e.g., a painted line one a ground surface of the road defining a lateral boundary of the lane). As yet another example, the road disturbance 215 may extend entirely across the road 200.

The vehicle computer 110 can identify collected data for the host vehicle 105 while operating the host vehicle 105 along the road 200. In this context, “collected data” are data describing movement and positions of vehicles (i.e., collected data are data measuring various vehicle attributes as the vehicle operates). That is, the collected data provide measurements describing how the host vehicle 105 operates. The collected data can include, for example, vehicle speed, steering angle, wheel-slip data, yaw, yaw rate, pitch, pitch rate, heading angle, sideslip angle (i.e., an angle of the vehicle's velocity relative to a longitudinal axis of the vehicle), steering wheel torque, a vehicle location, etc.

The collected data can be obtained or derived (e.g., according to known data processing techniques) from sensor 115 data. For example, the sensors 115 can capture data, e.g., image and/or video data, during operation of the host vehicle 105 and transmit the data to the vehicle computer 110. The vehicle computer 110 can then, for example, analyze the sensor 115 data (e.g., using pattern recognition and/or image analysis techniques) to identify the collected data of the host vehicle 105. As another example, the sensor 115 data can specify the collected data of the host vehicle 105 (e.g., wheel speed sensor 115 data specifying a speed of the host vehicle 105).

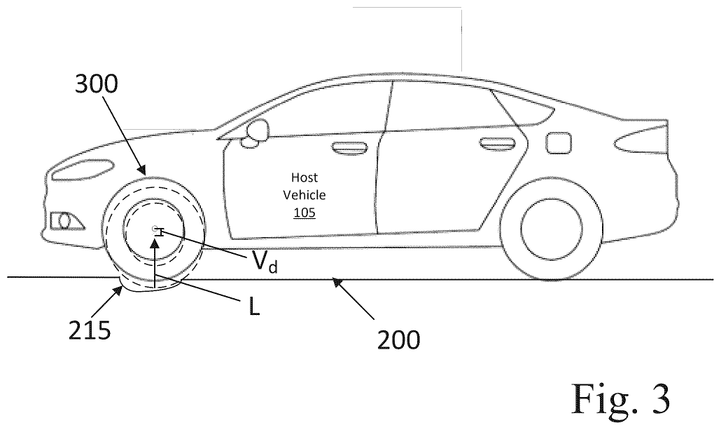

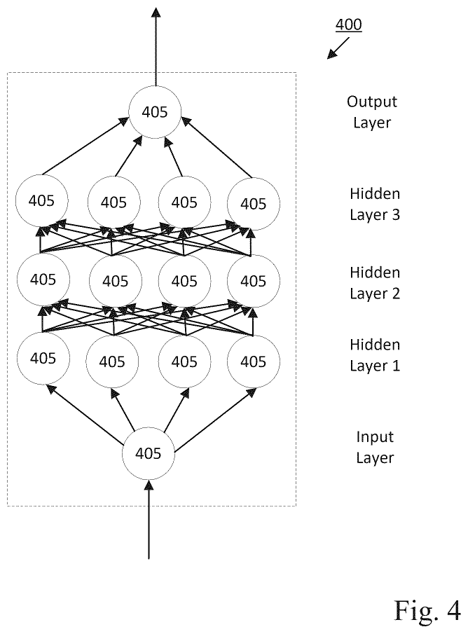

The vehicle computer 110 can input the collected data of the host vehicle 105 to a neural network, such as a deep neural network (DNN) 400 (see FIG. 4), that can be trained to accept the collected data as input and generate an output of a predicted load L exerted on the wheel 300 of the host vehicle 105 and a predicted vertical displacement V_{d} of the wheel 300. Alternatively, the vehicle computer 110 can transmit the collected data to the remote server computer 140 (e.g., via the network 135). In this situation, the remote server computer 140 can input the collected data into the DNN 400 to determine the predicted load L and the predicted vertical displacement V_{d}. The remote server computer 140 can then transmit the predicted load L and the predicted vertical displacement V_{d} to the vehicle computer 110 (e.g., via the network 135). A vertical component of the load L is shown in FIG. 3 for case of illustration, but it should be understood that the load L can include components extending parallel to (or along) one or more axes defined by a wheel coordinate system (e.g., a Cartesian coordinate system having an origin at a specified point on the wheel (e.g., a center of rotation of the wheel)) of the vehicle and/or moments about the one or more axes of the vehicle.

During operation, the host vehicle 105 may traverse a road disturbance 215. As used herein, “traverse a road disturbance” means traversing the ground surface from one point to another point on the ground surface with a road disturbance 215 between those two points on the ground surface. While traversing the road disturbance 215, the wheel 300 of the host vehicle 105 may move vertically and contact the road disturbance 215 (as shown in broken lines in FIG. 3). The vehicle computer 110 can identify the road disturbance 215 based on the predicted load L being greater than a load threshold and/or the predicted vertical displacement V_{d} being greater than a displacement threshold. For example, the vehicle computer 110 can compare the predicted load L to the load threshold. If the predicted load L is greater than the load threshold, then the vehicle computer 110 can identify a road disturbance 215 at a location of the host vehicle 105. If the predicted load L is less than or equal to the load threshold, then the vehicle computer 110 can determine that no road disturbance 215 is present at the location of the host vehicle 105. Alternatively, the remote server computer 140 can identify the road disturbance 215 based on comparing the predicted load L to the load threshold.

The load threshold specifies a maximum predicted load L exerted on a vehicle wheel during operation along a ground surface lacking a road disturbance 215. The load threshold may be stored (e.g., in a memory of the vehicle computer 110). The load threshold may be determined empirically (e.g., based on testing/simulation to determine a maximum predicted load exerted on a vehicle wheel when operating along various road surfaces that lack road disturbances).

Additionally, or alternatively, the vehicle computer 110 can compare the predicted vertical displacement V_{d} to the displacement threshold. If the predicted vertical displacement V_{d} is greater than the displacement threshold, then the vehicle computer 110 can identify the road disturbance 215 at the location of the host vehicle 105. If the predicted vertical displacement V_{d} is less than or equal to the displacement threshold, then the vehicle computer 110 can determine that no road disturbance 215 is present at the location of the host vehicle 105. Alternatively, the remote server computer 140 can identify the road disturbance 215 based on comparing the predicted vertical displacement V_{d} to the displacement threshold.

The displacement threshold specifies a maximum predicted vertical displacement V_{d} of a vehicle wheel during operation along a ground surface lacking a road disturbance 215. The displacement threshold may be stored (e.g., in a memory of the vehicle computer 110). The displacement threshold may be determined empirically (e.g., based on testing/simulation to determine a maximum predicted vertical displacement of a vehicle wheel when operating along various road surfaces that lack road disturbances).

Upon identifying the road disturbance 215, the vehicle computer 110 can determine that a location of the road disturbance 215 is a same location as the location of the host vehicle 105. The vehicle computer 110 can, for example, receive the location of the host vehicle 105 (e.g., from a sensor 115, a navigation system, a remote server computer 140, etc.). Alternatively, the remote server computer 140 can determine the location of the road disturbance 215 is a same location as the location of the host vehicle 105. In such an example, the remote server computer 140 can receive (e.g., via the network 135) the location of the host vehicle 105 (e.g., in a same or different transmission as the collected data).

The vehicle computer 110 can determine respective classifications of respective vehicle components 125 based on the predicted load L and the predicted vertical displacement V_{d}. The classification is healthy or unhealthy. In the present context, a vehicle component 125 is healthy when a predicted stress of the vehicle component 125 is less than a stress threshold for the vehicle component 125, and a vehicle component 125 is unhealthy when the predicted stress is greater than or equal to the stress threshold for the vehicle component 125. The vehicle computer 110 can store (e.g., in a memory thereof) respective stress thresholds for the respective vehicle components 125. The respective stress thresholds can be determined empirically (e.g., based on testing/simulation to determine stresses on the vehicle component 125 that generates strains within a predetermined range (e.g., 10%, 20%, etc.) of the yield strength of the vehicle component 125).

The vehicle computer 110 can determine the respective predicted stresses of respective vehicle components 125 with respective transfer functions. The respective transfer functions correlate the predicted load L and the predicted vertical displacement V_{d} to respective stresses on the respective vehicle components 125. The vehicle computer 110 can input the respective transfer functions into a cumulative stress model (i.e., a model that determines stresses on respective vehicle components 125 over time (e.g., as a result of traversing multiple road disturbances 215, 220)). The cumulative stress model can output the respective predicted stresses of the respective vehicle components 125. The vehicle computer 110 can then compare the respective predicted stresses to the respective stress thresholds to classify the respective vehicle components 125 as healthy or unhealthy.

The vehicle computer 110 can output a message based on one vehicle component 125 being classified as unhealthy. For example, the vehicle computer 110 can actuate a human-machine interface (e.g., a display screen, a speaker, etc.) to output an audio, visual, and/or haptic message to a user of the host vehicle 105. The message can identify the unhealthy vehicle component 125. Additionally, the message can instruct the user to operate the host vehicle 105 to a specified location for repair/maintenance of the unhealthy vehicle component 125. The vehicle computer 110 can transmit the respective classifications of the respective vehicle components 125 to the remote server computer 140 (e.g., via the network 135). The remote server computer 140 may be programmed to transmit (e.g., via the network 135) a message identifying unhealthy vehicle components 125 to a remote computer (e.g., associated with a repair/maintenance entity).

The vehicle computer 110 is programmed to update map data based on the road disturbance 215. For example, the vehicle computer 110 can receive map data from the remote server computer 140 (e.g., via the network 135). The map data can, for example, include locations of road disturbances 215, 220 along the road 200. The vehicle computer 110 can store the map data (e.g., in a memory thereof). Upon determining the location of the road disturbance 215, the vehicle computer 110 can update the stored map data to include the location of the road disturbance 215. Additionally, the vehicle computer 110 can update the stored map data to include the predicted load L and predicted vertical displacement V_{d} output from the DNN 400. The vehicle computer 110 can store the updated map data (e.g., in a memory thereof). Additionally, or alternatively, the vehicle computer 110 can provide the updated map data to the remote server computer 140 (e.g., via the network 135).

The vehicle computer 110 can be programmed to detect a second road disturbance 220 in the road 200 based on the map data. For example, the vehicle computer 110 can determine a location of the second road disturbance 220 from the map data. The vehicle computer 110 can then compare the location of the host vehicle 105 to the location of the second road disturbance 220. Upon determining that the second road disturbance 220 is in front of the host vehicle 105 (e.g., relative to a direction of travel of the host vehicle 105 along the road 200), the vehicle computer 110 can generate a planned path for the host vehicle 105 based on the second road disturbance 220. In one example, the vehicle computer 110 can generate the planned path to extend around the second road disturbance 220 (e.g., by changing a lane of operation of the host vehicle 105 to the target lane 210 (e.g., based on the target lane 210 being unoccupied and permitting operation in the direction of travel)). That is, the planned path can be generated to prevent the host vehicle 105 from traversing the second road disturbance 220. In another example, the vehicle computer 110 can generate the planned path to extend across the second road disturbance 220 (e.g., by maintaining the host vehicle 105 in the host lane 205 (e.g., based on a target lane 210 being occupied, the second road disturbance extending across multiple lanes 210, etc.). That is, the planned path can be generated to direct the host vehicle 105 to traverse the second road disturbance 220.

As used herein, a “path” is a set of points, e.g., that can be specified as coordinates with respect to a vehicle coordinate system and/or geo-coordinates, that the computer 110 is programmed to determine with a conventional navigation and/or path planning algorithm. A path can be specified according to one or more path polynomials. A path polynomial is a polynomial function of degree three or less that describes the motion of a vehicle on a ground surface. Motion of a vehicle on a roadway is described by a multi-dimensional state vector (e.g., that includes vehicle location, orientation, speed, etc.) determined by fitting a polynomial function to successive 2D locations included in the vehicle motion vector with respect to the ground surface, for example.

Further for example, the path polynomial p(x) is a model that predicts the path as a line traced by a polynomial equation. The path polynomial p(x) predicts the path for a predetermined upcoming distance x, by determining a lateral coordinate p, e.g., measured in meters:

$$p ( x ) = {a}_{0} + {a}_{1} x + {a}_{2} {x}^{2} + {a}_{3} {x}^{3} \qquad ( 1 )$$

where a₀ an offset, i.e., a lateral distance between the path and a center line of the vehicle at the upcoming distance x, a₁ is a heading angle of the path, a₂ is the curvature of the path, and a₃ is the curvature rate of the path.

In an example in which the planned path extends around the second road disturbance 220, the vehicle computer 110 may be programmed to maintain vehicle component 125 parameters. For example, the vehicle computer 110 can operate the host vehicle 105 along the planned path based on a selected operation mode. That is, the vehicle computer 110 may actuate one or more vehicle components 125 to move the host vehicle 105 along the planned path according to parameters specified by the selected operation mode. The selected operation mode may be selected based on a user input (e.g., received via a human-machine interface) specifying the current operation mode.

An operation mode is a measurable set of physical parameters for one or more vehicle components 125 (e.g., a steering component 125, a propulsion component 125, a suspension component 125, etc.) that constrains vehicle performance. For example, one operation mode may be a “Bump mode.” In the “Bump mode,” one or more parameters (e.g., a camber angle, a stiffness, a ride height, steering stiffness, etc.) of one or more vehicle components 125 (e.g., the suspension component 125, the steering component 125, etc.) may be specified so as to limit predicted loads exerted on a vehicle wheel and predicted vertical displacements of the vehicle wheel caused by the vehicle traversing various road disturbance. For example, the “Bump mode” may be determined or governed according to a look-up table, or the like, that associates various parameters for the vehicle components 125 with various road disturbances. The parameters of the “Bump mode” may be determined empirically (e.g., based on testing/simulation to determine parameters that minimize predicted loads and predicted vertical displacements when a vehicle traverses various road disturbances at various speeds). Other non-limiting examples of operation modes (that could similarly be specified according to a lookup table or the like) include “Sport mode,” “Track mode,” “Eco mode,” “Comfort mode,” “Off-road mode,” “Snow mode,” “Sand mode,” etc. The operation modes may be stored (e.g., in a memory of the vehicle computer 110).

In an example in which the planned path extends across the second road disturbance 220, the vehicle computer 110 may be programmed to adjust one or more parameters of one or more vehicle components 125. For example, the vehicle computer 110 can transition the host vehicle 105 from the selected operation mode to the “Bump mode” while the host vehicle 105 traverses the second road disturbance 220. In the “Bump mode,” the vehicle computer 110 can determine updated parameters for the vehicle components 125 based on the second road disturbance 220. For example, the vehicle computer 110 can access the map data to determine a second predicted load L and a second predicted vertical displacement V_{d} associated with the second road disturbance 220. The vehicle computer 110 can select the parameters of the vehicle components 125 included in the look-up table associated with the second predicted load L and/or the second predicted vertical displacement V_{d}. The vehicle computer 110 can then actuate one or more vehicle components 125 to traverse the second road disturbance 220 according to the selected parameters. In such an example, the vehicle computer 110 can transition the host vehicle 105 from the “Bump mode” to the selected operation mode after the host vehicle 105 traverses the second road disturbance 220.

The second vehicle 145 may be a leading vehicle or a trailing vehicle. A leading vehicle is a vehicle operating in front of the host vehicle 105 relative to the direction of travel of the host vehicle 105. A trailing vehicle is a vehicle operating behind the host vehicle 105 based on the direction of travel of the host vehicle 105.

When the second vehicle 145 is a leading vehicle (see FIG. 2B), the second computer 150 can identify the second road disturbance 220. For example, the second computer 150 can identify collected data of the second vehicle 145 during operation. The second computer 150 can then input the collected data of the second vehicle 145 to the DNN 400 that outputs a second predicted load L exerted on a wheel 300 of the second vehicle 145 and a second predicted vertical displacement V_{d} of the wheel 300 of the second vehicle 145. The second computer 150 can identify the second road disturbance 220 based on at least one of the second predicted load L and the second predicted vertical displacement V_{d} (e.g., in a same manner as discussed above regarding identifying the road disturbance). Upon identifying the second road disturbance 220, the second computer 150 can update map data based on the second road disturbance 220 (e.g., to include a location of the second road disturbance 220, the second predicted load L and the second predicted vertical displacement V_{d} in the same manner as discussed above regarding the vehicle computer 110 updating the map data). Additionally, the second computer 150 can transmit (e.g., via the network 135) the updated map data to the remote server computer 140. The remote server computer 140 can update the map to include the second road disturbance 220 based on aggregated data (as discussed further below). The remote server computer 140 can then transmit the updated map (e.g., via the network 135), including the second road disturbance 220, to the vehicle computer 110.

When the second vehicle 145 is a trailing vehicle (see FIG. 2A), the second computer 150 can operate the second vehicle 145 based on the road disturbance 215. For example, the second computer 150 can receive the updated map, including the road disturbance 215 identified by the vehicle computer 110, from the remote server computer 140 (e.g., via the network 135). The second computer 150 can access the updated map to detect the road disturbance 215. The second computer 150 can then generate a planned path based on the road disturbance 215 (e.g., in the same manner as discussed above regarding the vehicle computer 110 generating the planned path). When the planned path extends arounds the road disturbance 215, the second computer 150 can, for example, operate the second vehicle 145 along the planned path in a selected operation mode. When the planned path extends across the road disturbance 215, the second computer 150 can adjust parameters of one or more vehicle components (e.g., in the same manner as discussed above regarding the vehicle computer 110 adjusting parameters of vehicle components 125).

The remote server computer 140 may be programmed to generate (and/or update) the map data of the road 200 including the road disturbance 215, 220 based on aggregated data. Aggregated data means data from a plurality of computers 110, 150 that provide messages and then combining (e.g., by averaging and/or using some other statistical measure) the results. That is, the remote server computer 140 may be programmed to receive messages from a plurality of computers 110, 150 indicating one or more road disturbances 215, 220 along a road 200 based on data from a plurality of vehicles 105, 145. Based on the aggregated data indicating the road disturbance(s) 215, 220 (e.g., an average number of messages, a percentage of messages, etc., indicating a presence of the road disturbance(s) 215, 220), and taking advantage of the fact that messages from different vehicles 105, 145 are provided independently of one another, the remote server computer 140 can generate (and/or update) the map data to specify the road disturbance(s) 215, 220 and the predicted load(s) L and/or predicted vertical displacement(s) V_{d} corresponding to the road disturbance(s) 215, 220 based on the data from the plurality of vehicles 105, 145. The remote server computer 140 can store the map data (e.g., in a memory thereof). Additionally, the remote server computer 140 can transmit the map data to a plurality of vehicles 105, 145, e.g., via the network 135.

FIG. 4 is a diagram of an example deep neural network (DNN) 400 that can be trained to predict a predicted load L exerted on a wheel 300 of a vehicle 105, 145 and a predicted vertical displacement V_{d} of the wheel 300 based on collected data of the vehicle 105, 145. The DNN 400 can be a software program that can be loaded in memory and executed by a processor included in a computer 110, 140, 150, for example. In an example implementation, the DNN 400 can include, but is not limited to, a convolutional neural network (CNN), R-CNN (Region-based CNN), Fast R-CNN, and Faster R-CNN. The DNN includes multiple nodes, and the nodes are arranged so that the DNN 400 includes an input layer, one or more hidden layers, and an output layer. Each layer of the DNN 400 can include a plurality of nodes 405. While FIG. 4 illustrate three (3) hidden layers, it is understood that the DNN 400 can include additional or fewer hidden layers. The input and output layers may also include more than one (1) node 405.

The nodes 405 are sometimes referred to as artificial neurons 405, because they are designed to emulate biological, e.g., human, neurons. A set of inputs (represented by the arrows) to each neuron 405 are each multiplied by respective weights. The weighted inputs can then be summed in an input function to provide, possibly adjusted by a bias, a net input. The net input can then be provided to an activation function, which in turn provides a connected neuron 405 an output. The activation function can be a variety of suitable functions, typically selected based on empirical analysis. As illustrated by the arrows in FIG. 4, neuron 405 outputs can then be provided for inclusion in a set of inputs to one or more neurons 405 in a next layer.

As one example, the DNN 400 can be trained with ground truth data, i.e., data about a real-world condition or state. For example, the DNN 400 can be trained with ground truth data generated via a simulation system 500 (as discussed further below) and/or updated with additional data the remote server computer 140. Weights can be initialized by using a Gaussian distribution, for example, and a bias for each node 405 can be set to zero. Training the DNN 400 can include updating weights and biases via suitable techniques such as back-propagation with optimizations. Ground truth data can include, but is not limited to, data specifying objects, e.g., vehicles, road disturbances, etc., within an image or data specifying a physical parameter. For example, the ground truth data may be data representing objects and object labels. In another example, the ground truth data may be data representing an object, e.g., a vehicle, and a relative forces and movement the object, e.g., the vehicle, with respect to another object, e.g., a road disturbance.

During operation, the vehicle computer 110 identifies collected data of the host vehicle 105 (as discussed above) and provides the collected data to the DNN 400. The DNN 400 generates a prediction based on the received input. The output is a predicted load L exerted on a wheel 300 of a vehicle 105, 145 and a predicted vertical displacement V_{d} of the wheel 300 given the collected data of the vehicle 105, 145.

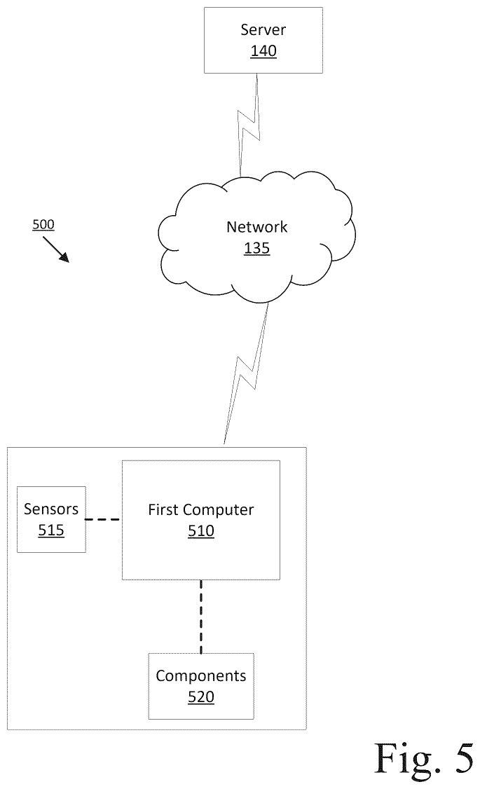

With reference to FIG. 5, an example simulation system 500 includes a first computer 510. The simulation system 500 can simulate operating conditions of a vehicle. The simulation system 500 may include hardware and software such as is known (or could be a system developed or built in the future). The simulation system 500 may include sensors 515 and vehicle components 520 comprising a vehicle subsystem, e.g., the propulsion (e.g., including a powertrain) subsystem, the steering subsystem, etc. As discussed further below, the simulation system 500 can simulate operation of a virtual vehicle and/or physical vehicle components 520. The computer 510 is generally arranged for communications on a communication network that can include a controller area network (CAN) or the like, and/or other wired and/or wireless mechanisms. Via the communication network, the computer 510 may receive messages (e.g., CAN messages) from the various devices (e.g., sensors 515) in the simulation system 500. For example, the sensors 515 may provide the computer 510 with data about the components 520 being used for simulation. As mentioned below, various controllers and/or sensors 515 may provide data to the computer 510 via the communication network. Additionally, the computer 510 may transmit messages to the remote server computer 140 (e.g., via the network 135).

The computer 510 can collect and process data about the vehicle components 520 being used for simulation. Based on the data, the computer 510 can actuate the vehicle components 520 during the simulation. For example, the vehicle subsystem being simulated can be the propulsion subsystem, a steering subsystem, etc. In these circumstances, the computer 510 can be a propulsion (e.g., powertrain) controller, a steering controller, etc. The computer 510 can control operation of the vehicle components 520 of the vehicle subsystem being simulated. For example, the operation can be controlling steering, controlling a human-machine interface, etc. The computer 510 may be an electronic control unit (ECU). An “electronic control unit” (ECU) is a device including a processor and a memory that includes programming (i.e., the memory stores instructions executable by the processor) to control one or more vehicle components 520.

Sensors 515 can include a variety of devices. For example, various controllers in a simulation system 500 may operate as sensors 515 to provide data via wired communication, e.g., data relating to subsystem and/or component status, to the computer 510. Further, other sensors 515 could include cameras, motion detectors, etc., i.e., sensors 515 to provide data for evaluating a position of a component, a condition of a component, etc. The sensors 515 could, without limitation, also include radar, LIDAR, and/or ultrasonic transducers.

The first computer 510 can determine ground truth data for the DNN 400 based on simulation data and/or sensor 515 data. That is, the first computer 510 can determine various predicted loads and various predicted vertical displacements for various vehicle operating conditions while traversing various road disturbances. As one example, the simulation system 500 can simulate one or more actual (i.e., physical) vehicle components 520. For example, the simulation system 500 can include each vehicle component 520 of a vehicle powertrain subsystem and a steering subsystem. As another example, the simulation system 500 can include vehicle components 520 constituting a portion of one or more vehicle subsystems. In this context, each vehicle component 125 includes one or more hardware components adapted to perform a mechanical function or operation-such as moving the vehicle, slowing or stopping the vehicle, steering the vehicle, etc. Non-limiting examples of components 520 include a propulsion component (that includes, e.g., an internal combustion engine and/or an electric motor, etc.), a transmission component, a steering component (e.g., that may include one or more of a steering wheel, a steering rack, etc.), or the like. In this situation, the first computer 510 can obtain sensor 515 data while actuating the various vehicle components 520 to traverse various road disturbances. Respective predicted loads and respective predicted vertical displacements can be determined or derived from the sensor 515 data (e.g., according to known data processing techniques) collected while actuating vehicle components 520 over various simulated road disturbances.

As another example, the simulation system 500 can simulate a virtual vehicle. In such an example, the first computer 510 can input a virtual vehicle into a vehicle dynamics model. The “vehicle dynamics model” is a physics-based kinematic or dynamic model describing vehicle motion that outputs respective vehicle states according to various control parameters. The vehicle dynamics model can model and output performance of the virtual vehicle (or one or more components thereof) actuated to move according to various vehicle operating conditions while traversing various road disturbances. By inputting the virtual vehicle to the vehicle dynamics model, the first computer 510 can obtain data specifying respective predicted loads and respective predicted vertical displacements while operating the virtual vehicle to traverse respective road disturbances. That is, the first computer 510 can simulate operation of the virtual vehicle traversing various road disturbances.

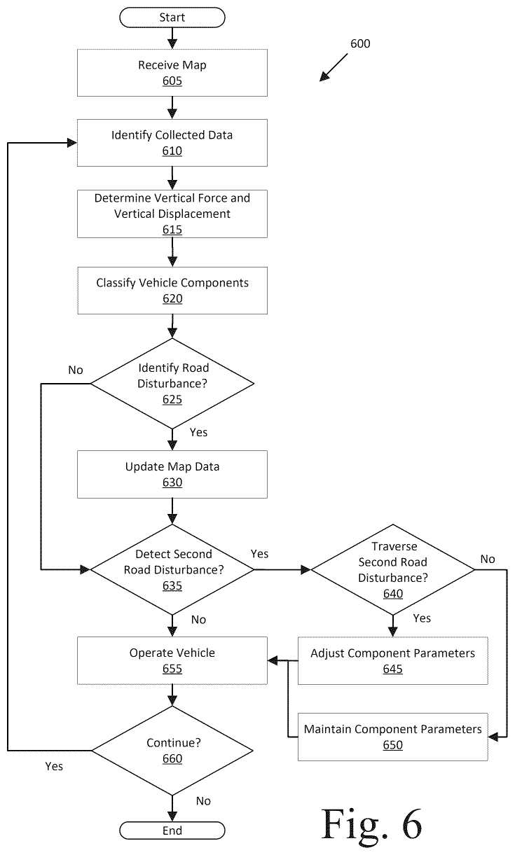

FIG. 6 is a diagram of an example process 600 for operating a vehicle. The process 600 begins in a block 605. The process 600 can be carried out by a vehicle computer 110 included in a host vehicle 105 executing program instructions stored in a memory thereof.

In the block 605, the vehicle computer 110 receives a map from a remote server computer 140. For example, the remote server computer 140 can generate (and/or update) the map based on aggregated data, as discussed above. The remote server computer 140 can then transmit the map to the vehicle computer 110 (e.g., via a network 135), as discussed above. The process 600 continues in a block 610.

In the block 610, the vehicle computer 110 identifies collected data of the host vehicle 105. For example, the vehicle computer 110 can obtain sensor 115 data during operation of the host vehicle 105. The vehicle computer 110 can then determine the collected data of the host vehicle 105 based on the sensor 115 data, as discussed above. The process 600 continues in a block 615.

In the block 615, the vehicle computer 110 determines a predicted load L exerted on a wheel 300 of the host vehicle 105 and a predicted vertical displacement V_{d} of the wheel 300 of the host vehicle 105. For example, the vehicle computer 110 can input the collected data to a DNN 400 trained to output the predicted load L and the predicted vertical displacement V_{d}, as discussed above. The process 600 continues in a block 620.

In the block 620, the vehicle computer 110 classifies respective vehicle components 125 as healthy or unhealthy. For example, the vehicle computer 110 can determine respective predicted stresses of the respective vehicle components 125 based on inputting a transfer function that correlates the predicted load L and the predicted vertical displacement V_{d} to respective stresses on the respective vehicle components 125 to a cumulative stress model that outputs the respective predicted stresses of the respective vehicle components 125, as discussed above. The vehicle computer 110 can then compare the respective predicted stresses to the respective thresholds to classify the respective vehicle components 125, as discussed above. If the vehicle computer 110 classifies one vehicle component 125 as unhealthy, then the vehicle computer 110 can provide, to the remote server computer 140, a message identifying the unhealthy vehicle component 125 (e.g., via the network 135), as discussed above. The process 600 continues in a block 625.

In the block 625, the vehicle computer 110 identifies a road disturbance 215 based on at least one of the predicted load L and the predicted vertical displacement V_{d}. For example, the vehicle computer 110 can identify the road disturbance based on at least one the predicted load L being greater than a force threshold and the predicted vertical displacement V_{d} being greater than a displacement threshold, as discussed above. If the vehicle computer 110 identifies the road disturbance 215, then the process 600 continues in a block 630. Otherwise, the process 600 continues in a block 635.

In the block 635, the vehicle computer 110 updates map data based on the road disturbance 215. For example, the vehicle computer 110 can update the map data to include a location of the road disturbance 215 (e.g., determined from a location of the host vehicle 105, as discussed above) and the predicted load L and the predicted vertical displacement V_{d}. The vehicle computer 110 can then provide the updated map data to the remote server computer 140 (e.g., via the network 135), as discussed above. The remote server computer 140 can update the map based on the updated map data, and then provide (e.g., via the network 135) the updated map to a plurality of vehicles 105, 145, as discussed above. The process 600 continues in a block 635.

In the block 635, the vehicle computer 110 detects whether a second road disturbance 220 is present in front of the host vehicle 105. For example, the vehicle computer 110 can access the updated map to determine a location of the second road disturbance 220, as discussed above. If the vehicle computer 110 detects the second road disturbance 220 in front of the host vehicle 105, then the process 600 continues in a block 640. Otherwise, the process 600 continues in a block 645.

In the block 640, the vehicle computer 110 determines whether a planned path prevents the host vehicle 105 from traversing the second road disturbance 220. For example, the vehicle computer 110 can generate a planned path along which to operate the host vehicle 105. If the planned path extends across (i.e., directs the host vehicle 105 to traverse) the second road disturbance 220, then the process 600 continues in a block 645. If the planned path extends around (i.e., prevents the host vehicle 105 from traversing) the second road disturbance 220, then the process 600 continues in a block 650.

In the block 645, the vehicle computer 110 adjusts one or more parameters of one or more vehicle components 125 based on the second road disturbance 220. For example, the vehicle computer 110 can transition the host vehicle 105 to a “Bump mode,” as discussed above. The process 600 continues in a block 655.

In the block 650, the vehicle computer 110 maintains vehicle component 125 parameters. For example, the vehicle computer 110 can maintain the host vehicle 105 in a selected operation mode, as discussed above. The process 600 continues in the block 655.

In the block 655, the vehicle computer 110 operates the host vehicle 105 along the planned path according to the vehicle component 125 parameters determined in one of the block 645 and the block 650. The process 600 continues in a block 660.

In the block 660, the vehicle computer 110 determines whether to continue the process 600. For example, the vehicle computer 110 can determine not to continue when the host vehicle 105 is in an OFF state. Conversely, the vehicle computer 110 can determine to continue when the host vehicle 105 is in an ON state. If the vehicle computer 110 determines to continue, the process 600 returns to the block 610. Otherwise, the process 600 ends.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board first computer, a computer workstation, a server, a desktop, notebook, laptop, or handheld computer, or some other computing system and/or device.

Computers and computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Perl, HTML, etc. Some of these applications may be compiled and executed on a virtual machine, such as the Java Virtual Machine, the Dalvik virtual machine, or the like. In general, a processor (e.g., a microprocessor) receives instructions (e.g., from a memory, a computer readable medium, etc.) and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

Memory may include a computer-readable medium (also referred to as a processor-readable medium) that includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of an ECU. Common forms of computer-readable media include, for example, RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the media, processes, systems, methods, heuristics, etc. described herein, it should be understood that, although the steps of such processes, etc. have been described as occurring according to a certain ordered sequence, such processes may be practiced with the described steps performed in an order other than the order described herein. It further should be understood that certain steps may be performed simultaneously, that other steps may be added, or that certain steps described herein may be omitted. In other words, the descriptions of processes herein are provided for the purpose of illustrating certain embodiments and should in no way be construed so as to limit the claims.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A system, comprising a computer including a processor and a memory, the memory storing instructions executable by the processor such that the processor is programmed to:
based on inputting collected data of a host vehicle to a machine learning program, determine a predicted load on a wheel of the host vehicle and a predicted vertical displacement of the wheel via output from the machine learning program;
identify a road disturbance traversed by the host vehicle based on at least one of the predicted load and the predicted vertical displacement; and
update map data to include the road disturbance.

2. The system of claim 1, wherein the processor is further programmed to:
determine a classification of a vehicle component based on at least one of the predicted load and the predicted vertical displacement, wherein the classification is one of healthy and unhealthy; and
output a message based on the vehicle component being unhealthy.

3. The system of claim 1, wherein the processor is further programmed to provide the updated map data to a remote computer, the computer being included in the host vehicle and the remote computer being a server.

4. The system of claim 3, further comprising the remote computer, including a second processor and a second memory storing instructions executable by the second processor such that the remote computer is programmed to:
update a map based on aggregated data including updated map data from a plurality of vehicles; and
provide the updated map to the computer and to a second computer.

5. The system of claim 4, further comprising the second computer, including a third processor and a third memory storing instructions executable by the third processor such that the second computer is programmed to:
upon detecting the road disturbance via the updated map, adjust a component parameter of a second vehicle based on the road disturbance; and
operate the second vehicle based on the adjusted component parameter while traversing the road disturbance.

6. The system of claim 5, wherein the second computer is included in the second vehicle.

7. The system of claim 1, wherein the processor is further programmed to, upon detecting, via a map, a second road disturbance, determine a planned path based on the second road disturbance.

8. The system of claim 7, wherein the second road disturbance is identified based on at least one of a second predicted load on a wheel of a second vehicle and a second predicted vertical displacement of the wheel, wherein, based on inputting collected data of the second vehicle to the machine learning program, the second predicted load and the second predicted vertical displacement are determined via output from the machine learning.

9. The system of claim 7, wherein the processor is further programmed to, upon determining the planned path extends around the second road disturbance, operate the host vehicle along the planned path.

10. The system of claim 7, wherein the processor is further programmed to:
upon determining the planned path traverses the second road disturbance, adjust a component parameter of the host vehicle based on the second road disturbance; and
operate the host vehicle based on the adjusted component parameter while traversing the second road disturbance.

11. A method, comprising:
based on inputting collected data of a host vehicle to a machine learning program, determining a predicted load on a wheel of the host vehicle and a predicted vertical displacement of the wheel via output from the machine learning program;
identifying a road disturbance traversed by the host vehicle based on at least one of the predicted load and the predicted vertical displacement; and
updating map data to include the road disturbance.

12. The method of claim 11, further comprising:
determining a classification of a vehicle component based on at least one of the predicted load and the predicted vertical displacement, wherein the classification is one of healthy and unhealthy; and
outputting a message based on the vehicle component being unhealthy.

13. The method of claim 11, further comprising providing, via a first computer, the updated map data to a remote computer, wherein the first computer is included in the host vehicle and the remote computer is a server.

14. The method of claim 13, further comprising:
updating, via the remote computer, a map based on aggregated data including updated map data from a plurality of vehicles; and
transmitting the updated map to the computer and to a second computer.

15. The method of claim 14, further comprising:
upon detecting the road disturbance via the updated map, adjusting, via the second computer, a component parameter of a second vehicle based on the road disturbance; and
operating, via the second computer, the second vehicle based on the adjusted component parameter while traversing the road disturbance.

16. The method of claim 15, wherein the second computer is included in the second vehicle.

17. The method of claim 11, further comprising, upon detecting, via a map, a second road disturbance, determining a planned path based on the second road disturbance.

18. The method of claim 17, further comprising:
based on inputting collected data of a second vehicle to the machine learning program, determining a second predicted load on a wheel of the second vehicle and a second predicted vertical displacement of the wheel via output from the machine learning; and
identifying the second road disturbance based on at least one of the second predicted load and the second predicted vertical displacement.

19. The method of claim 17, further comprising, upon determining the planned path extends around the second road disturbance, operating the host vehicle along the planned path.

20. The method of claim 17, further comprising:
upon determining the planned path traverses the second road disturbance, adjusting a component parameter of the host vehicle based on the second road disturbance; and
operating the host vehicle based on the adjusted component parameter while traversing the second road disturbance.
